(19) United States
(12) Patent Application Publication
(10) Pub. No.: US 2005/0083173 A1
(43) Pub. Date: Apr. 21, 2005

(54) Locking remote control

(76) Inventors: Ingrid H. Konupek, Sherman Oaks, CA (US); David H. Ben-Meir, Sherman Oaks, CA (US)

Correspondence Address: David H. Ben-Meir, 3818 Sherview Drive, Sherman Oaks, CA, 91403, US

(21) Appl. No.: 10/888,864

(22) Filed: Jul. 10, 2004

Related U.S. Application Data
(60) Provisional application No. 60/512,723, filed on Oct. 20, 2003.

(51) Int. Cl. H04Q 1/00; G05B 19/00

(52) U.S. Cl. 340/5.61; 340/5.54

(57) ABSTRACT

A remote control for one or more electronic devices, including audio/video components such as a television receiver, DVD player, and VCR, includes a user interface such as a keypad having multiple keys, an emitter that emits signals corresponding to the keys, and a locking circuit coupled to the keypad for setting and resetting a locking switch. Upon setting the locking switch, in response to depressing the keys, the emitter is preempted from emitting signals corresponding to the keys. Upon resetting the locking switch, the emitter is capable of emitting signals corresponding to the keys.

This application claims priority to a U.S. Provisional Application entitled “Locking Remote Control,” having Ser. No. 60/512,723 and filed on Oct. 20, 2003, which is hereby incorporated by reference as though fully set forth herein.

### BACKGROUND OF THE INVENTION

The field of the present invention relates to remote control devices for controlling one or more electronic devices, including in particular audio/video components such as a television receiver, VCR, DVD player, and audio receiver.

As most parents recognize, babies, toddlers and young children often show little interest in their own toys, and a much greater and long-lasting interest in household objects. One such household object is the remote control device that controls the television receiver and/or other audio/video components that together may comprise a household's entertainment system.

Unlike other household objects, however, a remote control device, particularly one that is used to control multiple electronic devices (i.e., a universal remote), is often a rather complicated apparatus to use, in that it has numerous features and modes for enabling and disabling even more numerous settings for the various devices that it may control. Thus, when, for example, a child plays with such a remote control, a significant bit of work may be required to undo the changes that the child might have inadvertently made to the devices' settings. Even worse, one may be unable to undo the child's “reprogramming” and must call a technician to restore the remote control and the electronic devices it controls to their proper settings. Furthermore, even if the child has not changed any device settings, the child often maintains pressure one or more keys of the remote control, causing the remote control to continuously transmit signals into nowhere in particular, and causing the remote control's batteries to dissipate unnecessarily.

If one is aware of a child's desire to handle a remote control, one might remove the disposable batteries that are installed in it, so that the remote control can be handled without such inconveniences. However, removing and replacing batteries can be time-consuming, and often one may forget to reinstall the batteries in the remote control after the child is finished playing with it. Also, sometimes the loose batteries are misplaced, forcing one to search for other available batteries or purchase more. Another alternative might be to hide the remote control or put it in an out-of-reach place. Often, however, one forgets where the remote control has been hidden, and any out-of-reach location is usually an inconvenient location as well.

However, mishandling of a remote control is not limited to babies, toddlers and young children. In one common scenario, an adult that is relaxing on a couch while watching television may roll over or otherwise inadvertently contact keys on the remote control and thereby change one or more of its settings or those of the television receiver and/or the other devices that the remote control operates. In another scenario, a guest in the house may use the “wrong” remote control or mishandle the proper remote control.

A need exists for a way to easily and elegantly overcome the inconveniences discussed above.

### SUMMARY OF THE INVENTION

The present invention provides, in one aspect, systems and methods for locking and unlocking a user interface of a remote control for an electronic device.

In a second separate aspect, the present invention is a remote control for one or more electronic devices that includes a user input interface such as a keypad having multiple keys or buttons, an emitter coupled to the keypad such that in response to depressing one of the multiple keys, the emitter emits a signal corresponding to the key, and a keypad locking circuit coupled to the keypad for setting and resetting a keypad locking switch. Upon setting the keypad-locking switch, in response to depressing any one of the multiple keys, other than the appropriate keys for resetting the keypad-locking switch, the emitter is preempted from emitting the signal corresponding to the depressed key.

In a third separate aspect, the present invention is a method of locking a remote control for an electronic device, including audio/video components such as a television receiver, DVD player, and VCR. The remote control preferably includes an emitter and a user interface having multiple input elements. The method preferably includes the steps of actuating at least one input element of the multiple input elements according to a predetermined locking protocol, setting an input interface locking switch in response to actuating the at least one input element according to the predetermined locking protocol, and preempting the emission of a signal corresponding to an actuated input element based on setting the input interface locking switch. Upon setting the input interface locking switch, in response to actuating any one of the multiple input elements, the emitter is preempted from emitting the signal corresponding to the actuated input element. Preferably, the input interface-locking switch is set by actuating two input elements in a predetermined order and within a predetermined amount of time of each other.

In a fourth separate aspect, the present invention is a method of unlocking a locked user interface of a remote control for one or more electronic devices, including audio/video components such as a television receiver, DVD player, and VCR. The remote control preferably includes an emitter and a user interface having multiple input elements. The method includes the steps of actuating at least one input element of the plurality of input elements according to a predetermined unlocking protocol, resetting an input interface locking switch in response to actuating the at least one input element, and permitting the emission of a signal corresponding to an actuated input element based on a reset state of the input interface locking switch. Preferably, the input interface-locking switch is reset by pressing two input elements in a predetermined order and within a predetermined amount of time of each other.

Further embodiments as well as modifications, variations and enhancements of the invention are also described herein.

### BRIEF DESCRIPTION OF THE DRAWINGS

FIG. 1 is a block diagram broadly describing a preferred embodiment of a remote control device with a locking feature for locking and unlocking the user input interface of the remote control device.

FIG. 2 is a block diagram depicting a preferred embodiment of a remote control device with a keypad and a locking feature for locking and unlocking the keypad.

FIG. 3 is a flow diagram depicting a preferred method for locking and unlocking the user interface of a remote control device, such as the remote control devices of FIGS. 1 and 2.

### DETAILED DESCRIPTION OF THE PREFERRED EMBODIMENTS

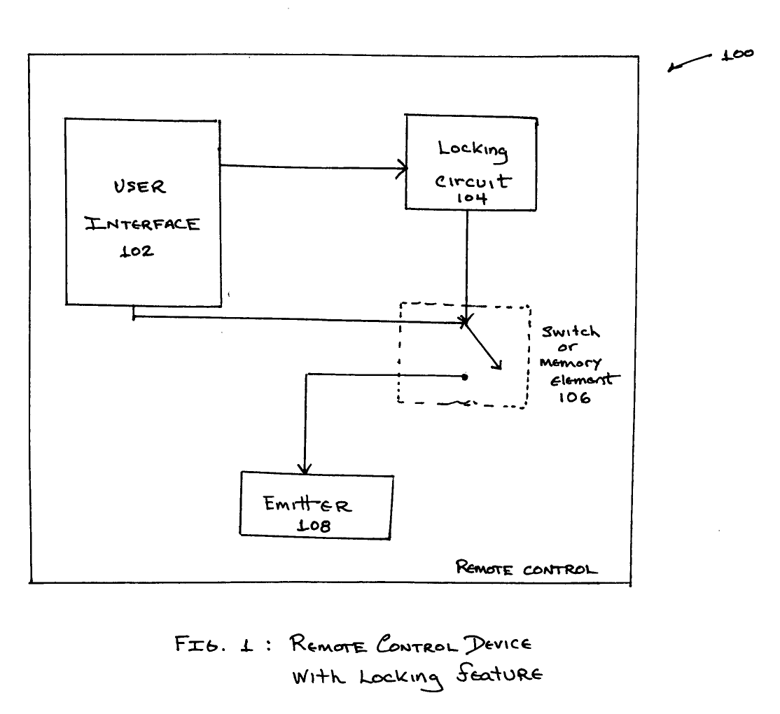

FIG. 1 conceptually depicts the basic elements of a preferred embodiment of a remote control device 100 including a locking feature for locking (e.g., deactivating) and unlocking (e.g., reactivating) the remote control device 100. The remote control device 100 comprises a user interface 102, a locking circuit 104, a switch 106 and an emitter 108. In the preferred embodiment, the user interface 102 provides a means for enabling the user to both input and receive information, although in FIG. 1 only the input interface 102 is depicted. The user interface102 is preferably electrically connected to the locking circuit 104 and switch 106. Locking circuit 104 refers to any mechanism for detecting whether the user has provided a particular input to the user interface 102 for unlocking or unlocking the remote control device 100, although locking circuit 104 preferably includes an electronic circuit. Detection of the particular predetermined input by the user triggers the setting or resetting of the switch 106.

Preferably, the electrical connection between the user interface 102 and the emitter 108 via the switch 106 allows the remote control device 100 to check the state of the switch 106 before any functions or values corresponding to the particular inputs made by the user on the user interface 102 are performed or entered. Such functions or values would typically be performed by the emitter 108, which emits a typically infrared signal to an electronic device such as a TV, DVD player, or VCR corresponding to the function or value that was input by the user on the user interface 102. Thus, for example, if the user input a “channel up” function, the state of the switch 106 is preferably checked before the “channel up” signal is transmitted by the emitter 108.

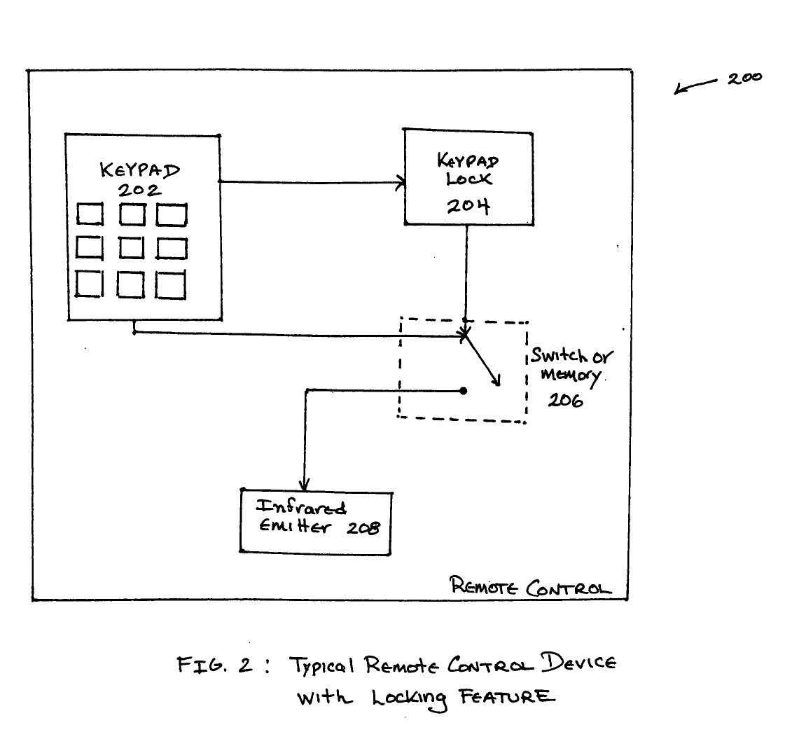

FIG. 2 depicts another preferred embodiment of a remote control device 200. The remote control device 200 includes a user input interface in the form of a keypad 202, a locking circuit, referred to in FIG. 2 as a keypad lock 204, a switch or memory 206, an infrared emitter 208 for transmitting infrared signals to one or more electronic devices and a display 210. The corresponding elements of FIGS. 1 and 2 preferably have the same minimum electrical connections with each other. Furthermore, the switch 206 is preferably electrically connected to the display 210.

The keypad 202 includes multiple keys or buttons 203 such as Keys A and B. The keypad 202 represents the user interface of a typical remote control device. As such, the remote control 200 may further or alternatively include other input elements such as a joystick and/or a touch screen. The keypad lock circuit 204 represents any electronic mechanism, including a circuit, for detecting the actuation of keys by a user that correspond to a protocol for locking and unlocking the remote control's user interface. The switch (or other memory) 206 may be any medium for storing as little as a bit of data. For example, the switch 206 may be a bit in a semiconductor memory of a much larger size, a flip-flop, a mechanical switch, etc. The display 210 is an optional element that preferably is in the form of a LCD screen for informing a user of the remote control 200 when the keypad 202 of the remote control 200 is in a “locked” state. However, the display 210 alternatively may include one or more LED or any other user output interface or mechanism (e.g., vibrating element, sound-providing element such as a speaker, etc.) for providing information to a user.

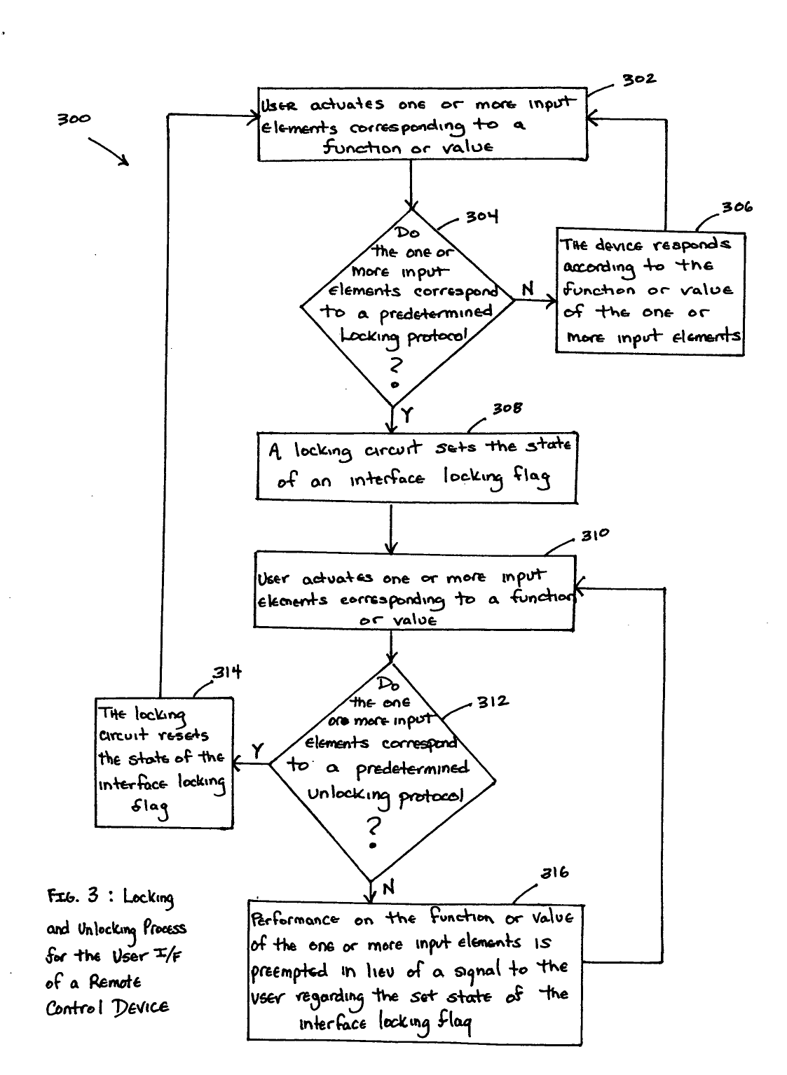

FIG. 3 is a process flow diagram depicting a preferred method 300 for locking and unlocking the user interface of a remote control device, such as those depicted in FIGS. 1 and 2. The method 300 proceeds on the basis that a keypad locking flag (i.e., the switch 206) is in a reset (i.e., unlocked) state. In a first step 302, a user actuates one or more input elements on the remote control device. Generally, actuating the input elements corresponds to a particular function and/or value. For example, the user may enter a “3” followed a “5”, which depending upon the remote control's (and possibly the television receiver's) present mode, may together represent the function of tuning the television receiver to channel 35.

Before the function and/or value are determined, however, conceptually the method 300 checks a condition 304 to determine whether the input elements that the user actuated correspond to locking the keypad. As a practical matter, however, the remote control in this step 304 simply interprets the actuated elements.

The protocol for locking the keypad of the remote control may take one of numerous forms. Typically, the protocol is set by the manufacturer and identified in a user's manual for the remote control, although optionally the particular protocol may be set by the user. One preferable protocol is to require the user to depress two particular keys at the same time. More preferably, the particular keys are at opposite ends of the keypad so as to minimize the probability of accidental locking of the user interface. As shown in FIG. 2, for example, the keypad locking protocol may require that the Keys A and B be depressed at the same time. Optionally, one or both of Keys A and B are labeled (e.g., “lock/unlock”) to indicate to the user that they are specific to the locking/unlocking function.

Another protocol may be to require that particular keys be depressed in a particular order and within a window of time of each other. Such a protocol is similar to a keypad locking protocol used for many cellular phones that are presently sold in the United States and that feature an exposed keypad. For example, the locking protocol for the remote control 200 of FIG. 2 may be that Key A be depressed followed by Key B within one second of pressing Key A. Alternative locking protocols may, of course, use input elements other than keys, such as by using a joystick to find the keypad locking option within an on-screen (such as a televisions screen or the display 210 of the remote control) pull-down menu.

Another protocol for locking the remote control may be the actuation of a single key or other actuator such as a slider, toggle switch or other such input element. In such a case, the input element is preferably not easily or inadvertently actuated by a user. For example, the input element may be recessed or require additional pressure to actuate. Another protocol may include the entry of a code (e.g., numeric code) that is predetermined by the manufacturer or set by the user. The same or a different code may be used to unlock the remote control, or alternatively, the code may be required only to unlock the remote. Many other locking protocols using the same or other input elements are possible that minimize the probability of accidentally locking or unlocking the remote control's user interface.

If the input elements actuated by the user do not correspond to the protocol for locking the remote control device, then, in a next step 306, the remote control preferably performs according to the function and/or value that the user specified. Once the step 306 is completed, the method 300 conceptually returns to the step 302 where the remote control awaits further input by a user signifying a new function and/or value.

If the input elements actuated by the user do correspond to the protocol for locking the remote control device, then, in a next step 308, the keypad locking circuit sets the state of the keypad locking flag 106, 206. This set state of the keypad locking flag 106, 206 represents that the user interface of the remote control is now “locked” from use. Optionally, a signal may be provided to the user of the locked state of the remote control's user input interface. Such a signal may be in the form of, for example, the illumination of an LED or the display of an icon or other message on an LCD screen of the remote control. In the preferred embodiment in which the remote includes an LCD or other screen, by continuously displaying a message on the screen upon locking the remote control, loss of battery power is minimized for the situation when a child inadvertently continues to press keys, while still providing a message to the user that the remote control is in a locked state.

In a next step 310 (similar to the step 302, except that the keypad is now locked), the user actuates one or more input elements corresponding to a function and/or value. Then, according to the method 300, a condition 312 is checked as to whether the input elements that the user just actuated correspond to the protocol for unlocking the input interface of the remote control device. In a preferred embodiment, the protocols for locking and unlocking the input interface are the same, so that the user does not have to remember more than one protocol for what are essentially two complementary functions. Thus, the particular protocols identified above for locking the remote control would preferably also apply to unlocking the input interface. The protocols are preferably such that the probability of unintentionally unlocking the remote control, such as might occur with a baby's or child's handling of the remote control or an adult's otherwise inadvertent contact with a keypad, would be minimized.

If the input elements actuated by the user in fact correspond to the protocol for unlocking the remote control, then, in a next step 314, the keypad locking circuit preferably resets the user interface locking flag 106, 206, effectively unlocking the user interface of the remote control. Once the step 314 is completed, the method 300 conceptually returns to the step 302 where the remote control awaits further input by a user signifying a new function and/or value.

If the input elements actuated by the user do not correspond to the protocol for unlocking the remote control device, then, in a next step 316, that function and/or value is preempted (i.e., not performed).

Optionally, in lieu of performance on the function and/or value, the remote control provides a signal to the user that the remote control device is in a “locked” state. The signal to the user potentially avoids the situation that the user may believe that the remote control is faulty or that the battery charge is low. Such a signal may take one or more of a number of possible forms. For example, the signal may be the illumination of an LED indicator that represents that the remote control is in a locked state. Alternatively, the remote control provides a signal to its display 210 that displays a message, such as an icon of a lock, regarding the present locked state of the remote control. Alternatively, the signal is one that is transmitted by the emitter to a television receiver that then displays a message regarding the locked state of the remote control's use interface on the television screen. Other methods of notifying the user of the locked state of the remote may be employed as are known in the art without departing from the spirit and scope of the present invention.

Further to this optional step, to minimize loss of battery power while still providing notification of the locked state of the remote control to the user, the signal may be provided up to a predetermined maximum number of times within a predetermined period. For example, the remote control may transmit the signal to the television receiver no more than once every twenty minutes despite the existence of keys being repeatedly or continuously depressed, such as may occur in the situation where a child continues to press keys or one is sitting on or otherwise inadvertently continuously depressing one or more keys of the remote control.

Once the step 316 is completed, the method 300 conceptually returns to the step 310 where the remote control, while remaining in the locked state, awaits further input by a user.

Alternatively, or in addition, an feature of the remote control (which is independent of the user interface locking feature) is that if one or more keys are continuously in a depressed state for more than a predetermined length of time (e.g., fifteen seconds), the remote control preferably ceases emitting any signal corresponding to the function and/or value of the key(s). In this embodiment, the one or more keys must be released and depressed again for the remote control to return to emitting the signal corresponding to the depressed key(s). Such a feature serves the purpose of preserving the remote control's battery power in the event of continuous inadvertent depression of one or more keys even of the keypad is not locked or does not include a keypad-locking feature.

While preferred embodiments of the invention have been described herein, and are further explained in the accompanying materials, many variations are possible which remain within the concept and scope of the invention. Such variations would become clear to one of ordinary skill in the art after inspection of the specification and drawings. The invention therefore is not to be restricted except within the spirit and scope of any appended claims.

1. A remote control for at least one electronic device comprising:
(a) a user input interface including a plurality of input elements;
(b) an emitter coupled to the user input interface, the emitter emitting a signal corresponding to an input element of the plurality of input elements in response to actuating the input element; and
(c) an input interface locking circuit coupled to the user input interface, the input interface locking circuit setting and resetting an input interface locking switch,
wherein upon setting the input interface locking switch, in response to actuating the input element, the emitter is preempted from emitting the signal corresponding to the input element.

2. The remote control of claim 1, wherein the user input interface comprises a keypad, the plurality of input elements comprises a plurality of keys, the input element comprises a key, and the key is actuated by pressing the key.

3. The remote control of claim 2, wherein upon resetting the input interface locking switch, in response to pressing the key, the emitter emits the signal corresponding to the key.

4. The remote control of claim 2, wherein the input interface locking switch is set and reset by depressing two keys at once.

5. The remote control of claim 2, wherein the input interface locking switch is set and reset by depressing two keys in a predetermined order and within a predetermined amount of time of each other.

6. The remote control of claim 2, wherein if the input interface-locking switch is set, and any one or more of the plurality of keys is depressed, the emitter emits a signal representing that the input interface-locking switch is set.

7. The remote control of claim 6, wherein a television system comprising a receiver for the signal from the emitter displays a message representing that the input interface-locking switch is set.

8. The remote control of claim 2 further comprising a user output interface, wherein if the input interface-locking switch is set, and any one of the plurality of keys is depressed, the user output interface outputs a message representing that the input interface locking switch is set.

9. The remote control of claim 8, wherein the user output interface comprises an LCD display.

10. The remote control of claim 9, wherein the at least one electronic device includes a television system.

11. The remote control of claim 2 further comprising a display, wherein upon setting the input interface-locking switch, the display displays a message representing that the input interface-locking switch is set.

12. A method of locking a remote control for at least one electronic device, the remote control comprising an emitter and a user interface having a plurality of input elements, the method comprising the steps of:
(a) actuating at least one input element of the plurality of input elements according to a predetermined locking protocol;
(b) setting an input interface locking switch in response to actuating the at least one input element according to the predetermined locking protocol; and
(c) preempting the emission of a signal corresponding to an actuated input element based on setting the input interface locking switch.

13. The method of claim 12, wherein the predetermined locking protocol comprises actuating two predetermined input elements at the same time.

14. The method of claim 13 further including a step after step (c) of providing a signal representing that the input interface locking switch is set when any one of the plurality of the keys is depressed.

15. The method of claim 14 further comprising a step after step (d) of receiving the signal and displaying a message representing that the input interface locking switch is set.

16. The method of claim 12, wherein the predetermined locking protocol comprises actuating two predetermined input elements in a predetermined order and within a predetermined amount of time of each other.

17. The method of claim 12 further comprising steps of:
(d) actuating at least one input element of the plurality of input elements according to a predetermined unlocking protocol;
(e) resetting the input interface locking switch in response to actuating the at least one input element; and
(f) permitting the emission of a signal corresponding to an actuated input element based on a reset state of the input interface locking switch.

18. A method of unlocking a remote control for at least one electronic device, the remote control comprising an emitter and an input interface having a plurality of input elements, the method comprising the steps of:
(a) actuating at least one input element of the plurality of input elements according to a predetermined unlocking protocol;
(b) resetting an input interface locking switch in response to actuating the at least one input element; and
(c) permitting the emission of a signal corresponding to an actuated input element based on a reset state of the input interface locking switch.

19. The method of claim 18, wherein the predetermined unlocking protocol comprises actuating two predetermined input elements at once.

20. The method of claim 18, wherein the predetermined unlocking protocol comprises actuating two predetermined input elements in a predetermined order and within a predetermined amount of time of each other.
